(19) United States
(12) Patent Application Publication
(10) Pub. No.: US 2008/0141979 A1
(43) Pub. Date: Jun. 19, 2008

(54) Injector clamp for vehicle

(76) Inventor: Won-Seok Chang, Ansan-si (KR)

Correspondence Address: MORGAN, LEWIS & BOCKIUS LLP (SF), One Market, Spear Street Tower, Suite 2800, San Francisco, CA, 94105, US

(21) Appl. No.: 11/853,209

(22) Filed: Sep. 11, 2007

(30) Foreign Application Priority Data
Dec. 15, 2006 (KR) 10-2006-0128715

(51) Int. Cl. F02M 61/14

(52) U.S. Cl. 123/470

(57) ABSTRACT

The present invention relates to an injector clamp for a vehicle and, more particularly, to an injector clamp of a leaf spring type for fixing a piezoelectric injector in a gasoline engine. For this purpose, the present invention provides an injector clamp for a vehicle, of which one side portion is formed as a planar mounting portion to be fixed on a mounting surface of a cylinder head by at least a bolt, a middle portion is formed as a planar extension portion extending from the planar mounting portion to the mounting surface of the cylinder head, and the other portion is formed as an injector supporting portion divided into at least two branches from the planar extension portion and bent convexly downward.

This application claims the benefit under 35 U.S.C. §119(a) on Korean Patent Application No. 10-2006-0128715 filed on Dec. 15, 2006, the entire contents of which are incorporated herein by reference.

### BACKGROUND OF THE INVENTION

1. Field of the Invention

The present invention relates to an injector clamp for a vehicle and, more particularly, to an injector clamp in the form of a leaf spring for fixing a piezoelectric injector of a gasoline engine.

2. Description of Related Art

As well known in the art, an injector installed to a combustion chamber in a direct injection engine is often equipped with an injector clamp, which is adapted for fixedly securing the injector against reaction force of injection and explosive pressure in the combustion chamber.

In case of the injector clamp applied to a diesel engine, it supports an injector rigidly as shown in FIG. 6.

FIG. 7 is a schematic diagram illustrating an operation principle of a conventional injector clamp, in which an injector is inserted into an injector insertion hole of a cylinder head and pressed down by the injector clamp.

A supporting point is provided between the bottom surface of a distal end of the injector clamp and the top surface of the cylinder head corresponding thereto. If the injector clamp is fixed to the cylinder head using a bolt (not shown) on the supporting point, the injector clamp pushes the injector down by the lever principle.

At this time, the injector clamp receives a reaction force from the injector.

Since the injector clamp receives a large reaction force from the injector when the pressure is increased during the fuel injection and by an explosion in the combustion chamber, an axial force of a fixing bolt is designed so as to sufficiently overcome such a reaction force.

That is, the position of the supporting point on the top surface of the cylinder head, the fixed position of the fixing bolt of injector clamp and the force of the injector clamp pushing the injector downwards by the axial force of the fixing bolt are determined.

Accordingly, the injector clamp is designed to be strong enough to resist against buckling and/or bending forces by the reaction force from the injector and the clamp is assumed as a rigid body when designing the same.

Here, the force that the injector clamp pushes the injector downwards is about 7,000 to 10,000 N and the thickness of the injector clamp is more than 10 mm.

The conventional injector clamp can be applied to an injector for a diesel engine having an axial force of more than 7,000 to 10,000 N since the injector itself is very strong. However, the conventional injector clamp cannot be applied to a piezoelectric injector mounted in a spray-guided gasoline direct injection (GDI) engine.

The reason is clarified from FIG. 8. That is, for the piezoelectric injector of the spray-guided GDI engine, elements constituting a piezo-actuator unit are directly connected to a valve and a thermal compensator compensating the length variation occurring due to an increase in temperature and so on are configured very weak against an external force as shown in FIG. 8. Accordingly, the axial force range that the injector can resist is about 700 to 1,000 N that is just a level of one-tenth of that of the injector for the diesel engine.

Accordingly, in case of designing the conventional injector clamp, the tightening torque of the fixing bolt should be set at a level of one-tenth; however, if so, it is impossible to ensure a sufficient frictional force between the fixing bolt and the cylinder head. As a result, there occurs a problem in that the bolt is loosened by vibration of the engine and so on.

Moreover, since it is difficult to control the torque with the one-tenth level, it is impossible to ensure the axial force of the injector.

If the fixing bolt of the injector clamp is loosened or the axial force of the injector is not ensured in the spray-guided GDI engine, the injector may be separated from the engine during compression and explosion strokes and thereby the sufficient pressure of the combustion chamber is not supplied, thus not performing a normal ignition of the engine. Furthermore, since fuel is continuously injected and ignition sparks are continuously generated by an ignition plug, it may cause a fire in the vehicle in the worst case.

Accordingly, it is necessary to design an injector clamp in the form of a new concept different from the conventional one, in which the axial force of the injector is ensured, the injector clamp is firmly supported and, at the same time, the injector clamp is not fractured.

Hereupon, Korean Patent Publication No. 2001-0061134 has disclosed an injector clamp including a support portion bent using an elastic material; however, it has a drawback in that it cannot sufficiently support a reaction force of an injector since a fixing bolt is located in the middle of the injector clamp.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been contrived to solve the above-described drawbacks of the conventional injector clamps. In one aspect, the present invention provides an injector clamp for a vehicle, one end of which is configured to be fixed to a cylinder head by bolts and the like, and the other end of the injector clamp is configured to elastically support the injector. Therefore, the injector clamp is capable of stably holding the injector while effectively dealing with reaction force transferred to the injector.

In order to accomplish the above objectives, one exemplary embodiment of the present invention provides an injector clamp for a vehicle, the injector clamp comprising one end portion formed as a planar mounting portion to be coupled on a mounting surface of a cylinder head by bolts; a middle portion formed as a planar extension portion extending from the planar mounting portion to an edge of the mounting surface of the cylinder head; and the other end portion formed as an injector supporting portion with a level difference from the planar extension portion. The injector supporting portion is divided into two branches that are extended from the planar extension portion and bent convexly downward.

As a preferred embodiment, the thickness of the injector clamp is about 0.8 to 2.0 mm.

As another preferred embodiment, a pair of bolt fixing holes is formed on the planar mounting portion of the injector clamp.

As still another embodiment, a washer is inserted between the bottom surface of the planar mounting portion of the injector clamp and the mounting surface of the cylinder head so that the planar mounting portion and the planar extension portion are spaced apart from the mounting surface of the cylinder head, thus providing an elastic force to the injector supporting portion.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view depicting an injector clamp for a vehicle in accordance with the present invention;

FIG. 2 is a schematic diagram depicting a mounting state of the injector clamp for a vehicle in accordance with the present invention;

FIG. 3 is a sectional view depicting a mounting state of the injector clamp for a vehicle in accordance with the present invention;

FIG. 4 is an experimental example of the injector clamp for a vehicle in accordance with the present invention and a schematic diagram illustrating a force acting to an injection clamp when a combustion chamber pressure is increased;

FIG. 5 is a schematic diagram illustrating a measurement rig for measuring the pressing pressure applied to the injector clamp for a vehicle in accordance with the present invention and a method for the measurement;

FIG. 6 is a schematic diagram depicting a conventional injector clamp for a diesel engine;

FIG. 7 is a schematic diagram illustrating a principle of the injector clamp of FIG. 6;

FIG. 8 is a schematic diagram illustrating a piezoelectric injector for a gasoline engine; and

FIGS. 8-10 are tables illustrating the results of the numerical analyses of two clamps of t=0.8 mm and t=1.0 mm according to the displacement amounts of the injector clamps in accordance with the present invention.

Reference numbers refer to the same or equivalent parts of the present invention throughout the several figures of the drawing.

### DETAILED DESCRIPTION OF THE INVENTION

Hereinafter, reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

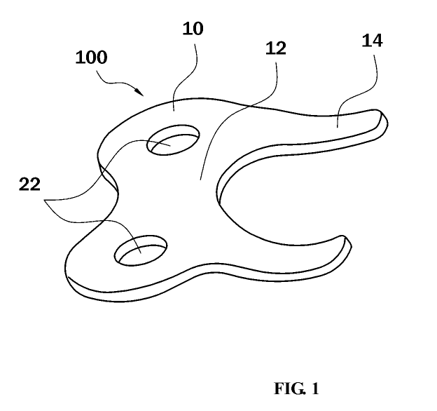

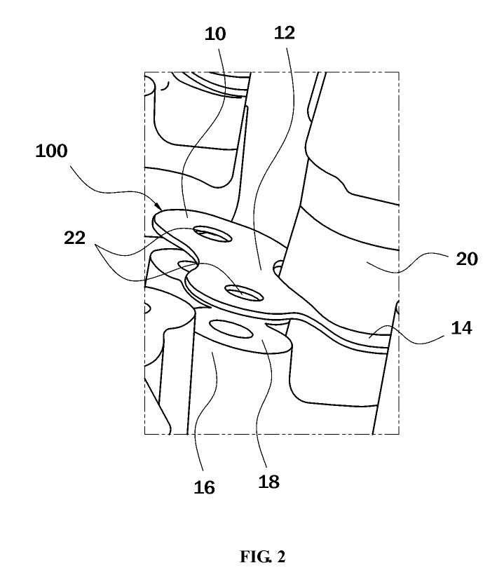

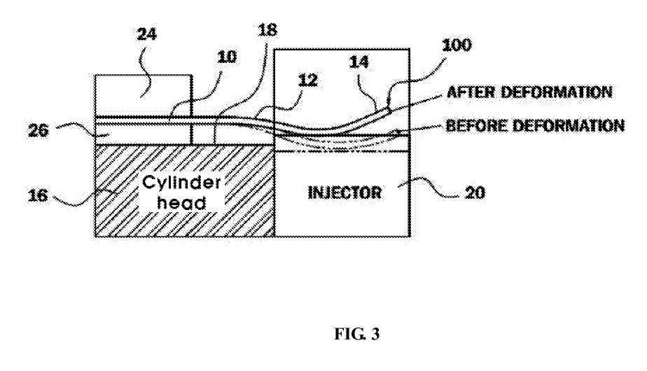

FIG. 1 is a perspective view depicting an injector clamp for a vehicle in accordance with the present invention. FIG. 2 is a schematic diagram depicting a mounting state of the injector clamp for a vehicle in accordance with the present invention. FIG. 3 is a sectional view depicting a mounting state of the injector clamp for a vehicle in accordance with the present invention.

Referring to FIGS. 1 and 2, an injector clamp 100 of the present invention may be divided roughly into three portions: a planar mounting portion 10 mounted on and fixed to a cylinder head 16, an injector supporting portion 14 elastically supporting an injector 20, and a planar extension portion 12 extending to connect the planar mounting portion 10 and the injector supporting portion 14 integrally.

The planar mounting portion 10 has a symmetrical shape as if two disks are connected to each other and bolt fixing holes 22 penetrating the disks are formed.

Accordingly, the planar mounting portion 10 is closely coupled to a mounting surface 18 of the cylinder head 16 and fixed by bolts 24.

The planar extension portion 12 is a portion extending from the planar mounting portion 10 to a distal edge of the mounting surface 18 of the cylinder head 16 in a parallel direction.

The injector supporting portion 14 is a portion divided into two branches from the planar extension portion 12 and has a shape bent convexly downward.

It is preferable that the injector clamp 100 of the present invention comprising the planar mounting portion 10, the extension portion 12 and the injector supporting portion 14 be formed to have a thickness of about 0.8 to 2.0 mm so as to provide an elastic force against the reaction force of the injector 20.

Especially, a washer 26 may be inserted between the bottom surface of the planar mounting portion 10 of the injector clamp 100 and the mounting surface 18 of the cylinder head 16 as shown in FIG. 3. The planar mounting portion 10 and the extension portion 12 are spaced upward from the mounting surface 18 of the cylinder head 16 by the washer 26, thus providing an elastic force to the injector supporting portion 14 like the lever principle.

In more detail, in a state where the planar mounting portion 10 of the injector clamp 100 is coupled to the cylinder head 16 by the bolts 24, if a force is applied to the planar extension portion 12 and the injector supporting portion 14, they are elastically deformed like the lever principle. Here, the amount of elastic deformation may be adjusted by the variation of the height of the washer 26 inserted between the cylinder head 16 and the planar mounting portion 10. Screws or other fixing means can be used in place of bolts.

In the injector clamp of the present invention as described above, it is possible to ensure the supporting force of the injector clamp itself and, the same time, control the axial force of the injector in a range of 700 to 1,000 N with the variation of height of washer 26, which can be understood through an experimental example to be described below.

FIG. 5 is a schematic diagram illustrating a measurement rig for measuring pressing pressure applied to the injector clamp 100 for a vehicle in accordance with the present invention and a method for the measurement.

A rig having a structure as depicted in FIG. 5 was designed and prepared for verifying the axial force of the injector clamp 100 in accordance with the present invention.

The rig is made of the same material as the actual cylinder head and the axial force acting to the injector by the injector clamp was measured by using a load cell.

Through such an experiment, the axial force applied from the injector clamp to the injector was verified, in which it was possible to select the optimal height of the washer so as to enable the injector clamp to be elastically deformed, thus obtaining an appropriate axial force.

Subsequently, when the injector clamp is deformed, numerical analyses were performed to verify whether the injector clamp is deformed within the elastic range and identify the deformation amount of the injector clamp that provides the axial force of the injector in the range of about 700 to 1,000 N.

The injector clamp of the present invention may be made of steel sheet such as SPS1, SK5, etc., and such materials have a Young's modulus of about 220 GPa and yield strength of about 1,000 MPa.

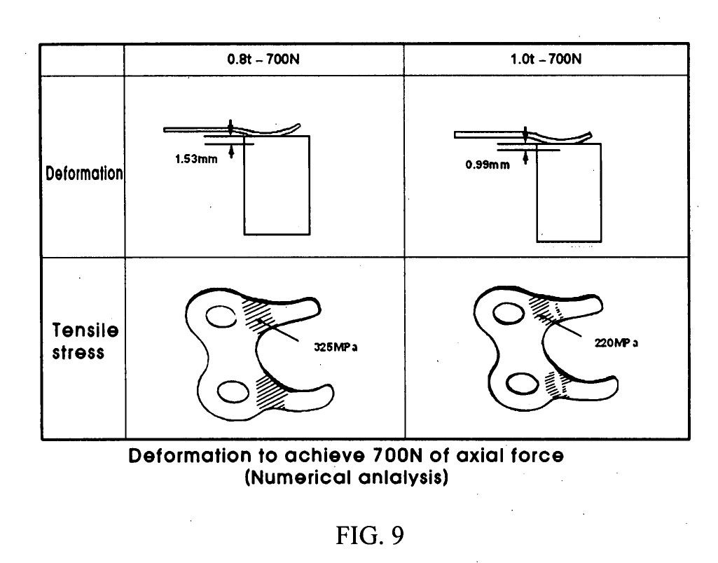

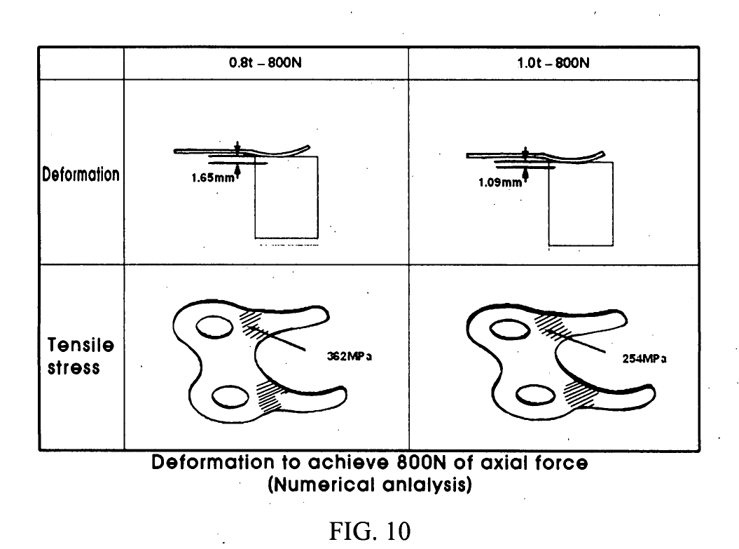

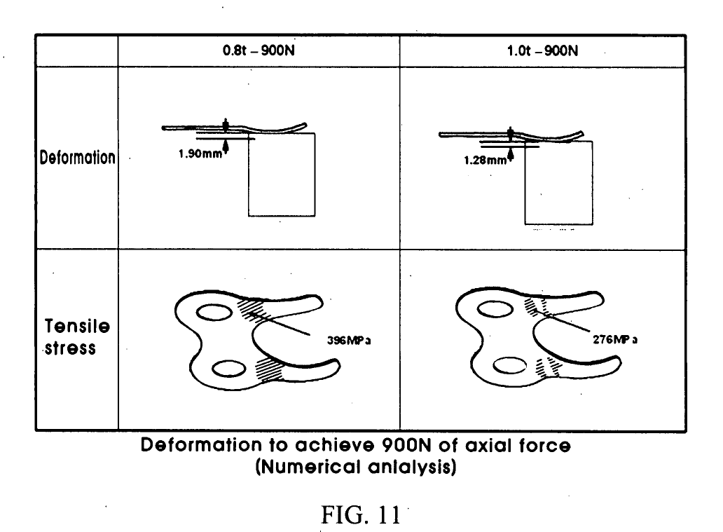

The results of the numerical analyses of two clamps of t=0.8 mm and t=1.0 mm according to the displacement amounts of the injector clamps are shown in the following FIGS. 9-11.

It could be understood from the results of the numerical analyses shown in FIGS. 9-11 that the tensile stress was a level below 40% of the yield stress and the injector clamp of the present invention did not cause a yield deformation or not fractured when it was used in a given axial force range of 700 to 900 N.

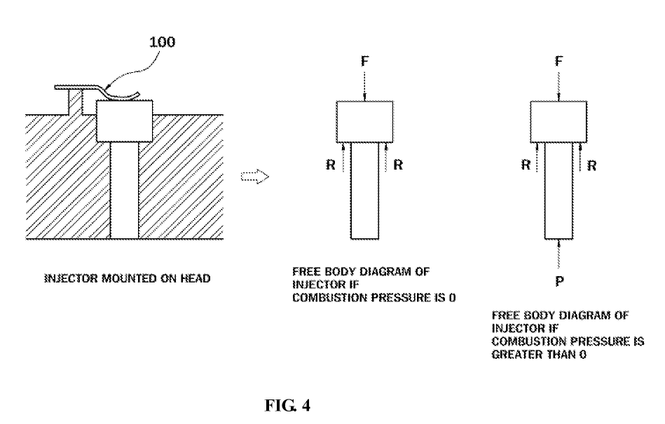

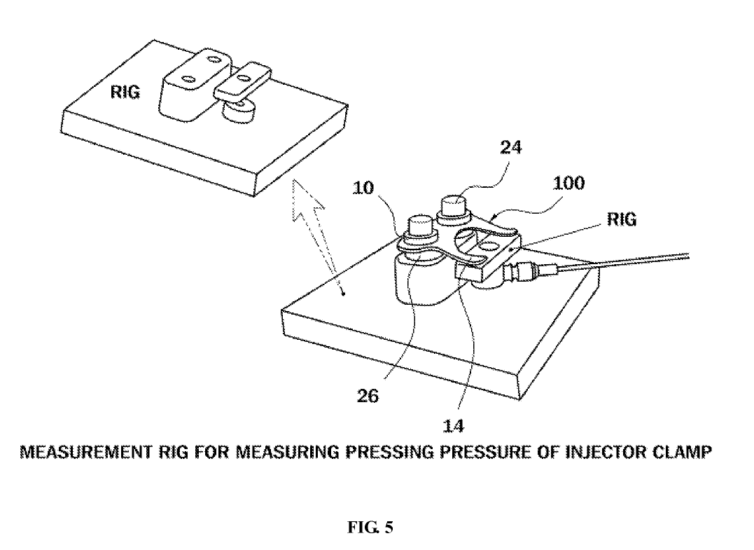

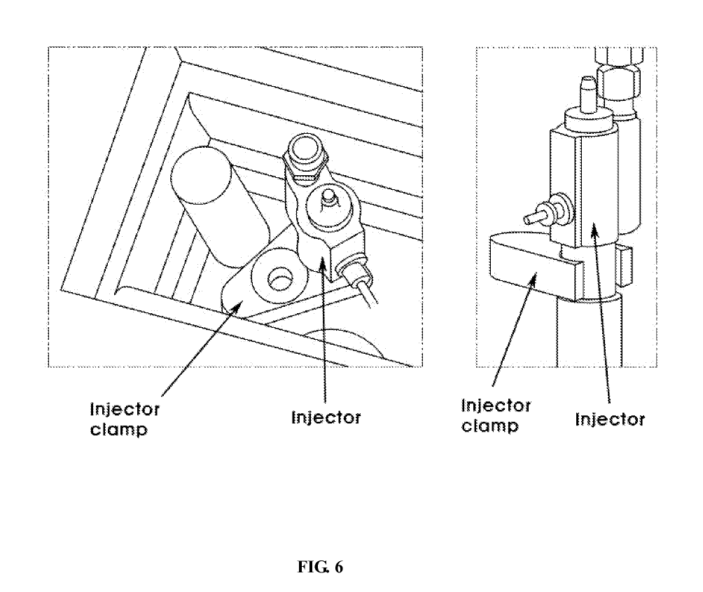

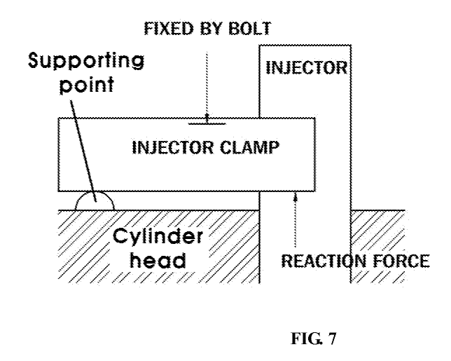

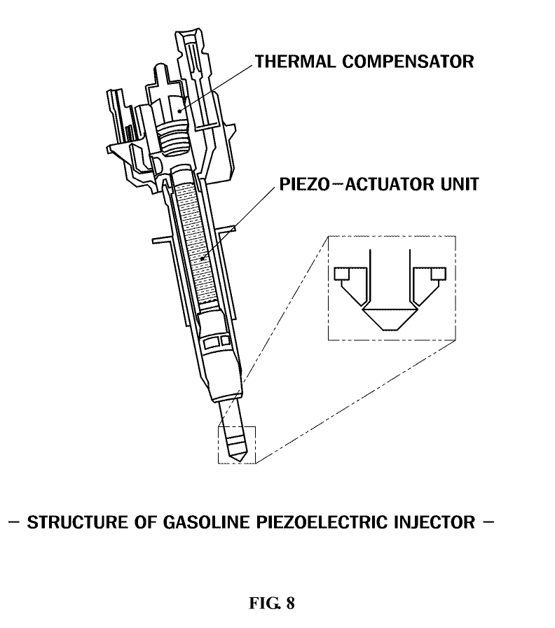

FIG. 4 is an experimental example of the injector clamp for a vehicle in accordance with the present invention and a schematic diagram illustrating a force acting to an injector clamp when a combustion chamber pressure is increased.

That is, an experiment was performed to examine whether or not the injector clamp of the present invention would cause a yield deformation or be fractured when the combustion chamber pressure is increased during the explosion stroke in the combustion chamber.

In a free body diagram of FIG. 4, an axial force F acting to the injector by an elastic deformation of the injector clamp is equal to a summation of reaction force R acting from the head to the injector, if the combustion chamber pressure is equal to the atmospheric pressure.

F=ΣR (if combustion pressure is 0).

Meanwhile, if the combustion chamber pressure is increased, the elastic deformation amount of the injector clamp and the axial force F acting to the injector are not varied, and a force P applied to the injector by the combustion chamber pressure lessens the reaction force R from the head, that is:

F=ΣR+P (if the combustion pressure is greater than 0).

Accordingly, the injector clamp of the present invention can operate regularly regardless of where or not there is a pressure in the combustion chamber.

As described above, the injector clamp in accordance with the present invention, of which one end is firmed fixed to the cylinder head by bolts and the other end is mounted to elastically support the injector, can maintain a clamping force and, at the same time, elastically support the reaction force of the injector.

Especially, the injector clamp of the present invention provides an advantage in that it can be applied to the piezoelectric injector used in the spray-guided GDI engine.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. An injector clamp for a vehicle, the injector clamp comprising:
one end portion formed as a planar mounting portion to be coupled to a mounting surface of a cylinder head by fixing means;
a middle portion formed as a planar extension portion extending from the planar mounting portion to an distal edge of the mounting surface of the cylinder head; and
the other end portion formed as an injector supporting portion extending from the planar extension portion having a height difference.

2. The injector clamp for a vehicle as recited in claim 1,
wherein the injector supporting portion is divided into at least two branches from the planar extension portion and bent convexly downward.

3. The injector clamp for a vehicle as recited in claim 1,
wherein the thickness of the injector clamp is about 0.8 to 2.0 mm.

4. The injector clamp for a vehicle as recited in claim 1,
wherein at least a bolt fixing hole is formed on the planar mounting portion of the injector clamp.

5. The injector clamp for a vehicle as recited in any one of claims 1 to 4,
wherein at least a washer is inserted between the bottom surface of the planar mounting portion of the injector clamp and the mounting surface of the cylinder head so that the planar mounting portion and the extension portion are spaced apart from the mounting surface of the cylinder head, thus providing an elastic force to the injector supporting portion.
